(19) United States
(12) Patent Application Publication
(10) Pub. No.: US 2025/0176506 A1
(43) Pub. Date: Jun. 5, 2025

(54) INSTALLATION FOR FARMING AQUATIC ORGANISMS, SALT COMPOSITION, AND SALTWATER OR BRACKISH WATER FOR SUCH AN INSTALLATION

(71) Applicant: INFINITESEA GMBH, Völklingen (DE)

(72) Inventor: Andreas MÄCK, Saarlouis (DE)

(21) Appl. No.: 18/725,629

(22) PCT Filed: Jan. 9, 2023
(86) PCT No.: PCT/EP2023/050304

§ 371 Date: Jun. 28, 2024

(30) Foreign Application Priority Data
Jan. 10, 2022 (LU) LU501230

(51) Int. Cl. A01K 63/00

(52) U.S. Cl. CPC A01K 63/003

(57) ABSTRACT

The invention relates to an installation for farming aquatic organisms, in particular fish or crustaceans, which has a rearing tank containing saltwater or brackish water, wherein the saltwater or brackish water is producible or produced using a salt composition that contains between 70 mol % and 99.9 mol % sodium chloride (NaCl) and between 0.1 mol % and 30 mol % magnesium chloride (MgCl₂), in each case in relation to the total amount of substance in the salt composition. The salt composition is expediently sulphate-free or at least has a low sulphate content. The invention furthermore relates to a salt composition for producing brackish water or saltwater for such an installation, to brackish water or saltwater, and to a method for producing the brackish water or saltwater, and to an aquatic organism that has been farmed in such an installation.

The invention relates to an installation for farming aquatic organisms, in particular fish or crustaceans, which has a rearing tank containing saltwater or brackish water, wherein the saltwater or brackish water is producible or produced using a salt composition that contains between 70 mol % and 99.9 mol % sodium chloride (NaCl) and between 0.1 mol % and 30 mol % magnesium chloride (MgCl₂), in each case in relation to the total amount of substance in the salt composition. The invention furthermore relates to a salt composition for producing brackish water or saltwater for such an installation, to brackish water or saltwater and to a method for producing the brackish water or saltwater, and to an aquatic organism that has been farmed in such an installation.

CN 1321913 C describes a salt composition as an artificial seawater additive, for example for fish farming, and a process for its production. A low-sulphate salt composition is known from CN 1321913 C. However, a sulphate-free composition is not described.

JP 2006006150 A describes salt compositions which can be used for farming shrimps. From paragraph a composition is known which contains 85 mol % NaCl, 6.5 mol % MgCl₂, 3.2 mol % MgSO₄ and 1.9 mol % CaSO₄. Thus, a low-sulphate salt composition is described, but not a sulphate-free one.

Aquaculture is known from the state of the art for farming aquatic organisms such as fish, mussels or crabs. In existing bodies of water, separate ponds, flow channels, basins or net pens are usually used in which the organisms grow until they are harvested. In coastal regions in particular, fish are usually kept in net pens, as existing saltwater or brackish water can be used.

Aquafarming is known as a form of inland aquaculture in so-called recirculation systems with rearing tanks. To produce the saline water used for this purpose, which can be artificial seawater, for example, in which the aquatic organisms are farmed in the rearing tanks until they are harvested, sea salt obtained from seawater is usually dissolved in tap water, groundwater or surface to create a habitat typical for the animals to be farmed. This artificial seawater usually has a high sulphate content.

While the farm water in aquaculture systems in flowing waters or fjords is generally not cleaned from excrement and food residues and the water is exchanged by flowing through the rearing net pens, recirculation systems require several filter stages to clean the water in the rearing tanks. Despite permanent filtration and water circulation, a 1 to 4 mm thick layer, the so-called sediment, can form at the bottom of the rearing tanks, e.g. in corners or in water filter systems, which consists of food residues and excrements of aquatic organisms and in which microorganisms colonize. Oxygen can only penetrate a few μm deep into the sediment, as the oxygen is used directly for microbial decomposition processes. Penetration depths of between 20 and 100 μm are typical, depending on various parameters.

The inventor has recognized that microorganisms living in the sediment use sulphate instead of oxygen as an electron acceptor for their metabolism, whereby hydrogen sulphide (H₂S) is formed and released into the water of the rearing tank. As a result, a concentration of H₂S that is lethal for aquatic organisms can be reached locally in the sediment area, which concentration can lead to harvest loss, i.e. the death of aquatic organisms that stay in this area only for a short time. All aquacultured fish are particularly sensitive to hydrogen sulphide, especially Atlantic salmon (Salmo salar), yellowtail kingfish (Seriola lalandi) and rainbow trout (Onchorrynchis mykiss). Among crustaceans, white tiger prawns (Litopenaeus vannamei) and black tiger prawns (Panaeus monodon) are particularly affected.

The inventor has also recognized that this problem is solved by sulphate-free brackish water or saltwater, and that up to a certain sulphate concentration there is no danger to aquatic organisms, i.e. only a quantity of H₂S that is harmless to aquatic organisms is formed in the sediment.

At the same time, a salt composition is created to produce brackish water or saltwater in which the aquatic organisms thrive particularly well and are supplied with all the ions required for farming in sufficient quantities. This ensures that the growth rates required for economic farming are achieved.

The invention is based on the task of creating an installation comprising brackish water or saltwater for farming aquatic organisms of the afore-mentioned type, in which no hydrogen sulphide is released into a rearing tank of the installation or only in an amount which is harmless to the aquatic organisms.

According to the invention, the problem is solved in that the salt composition is sulphate-free or that at least a low sulphate content.

A sulphate-free salt composition has no sulphate at all, while salt composition with a low sulphate content has a maximum of 5 mol % of a sulphate in relatin to the total amount of substance in the salt composition, preferably the maximum 5 mol % of sulphate consists of magnesium sulphate.

It is conceivable that the sulphate comes from a solution of sodium and/or potassium sulphate. The use of mixtures of different sulphate salts is also conceivable.

Advantageously, it is ensured that ions required for particularly good thriving of aquatic organisms are present in sufficient quantities in brackish water or saltwater produced with the salt composition according to the invention.

A sulphate-free salt composition or a salt composition that has a low sulphate content is achieved in particular by using a chloride salt, for example magnesium chloride, as a substitute for a sulphate salt, for example magnesium sulphate. In the salt composition according to the invention, a sulphate salt is always replaced by a chloride salt. Advantageously, this substitution allows the ion ratios, in particular the cation ratios, of the artificial saltwater or brackish water to be produced, for example magnesium to calcium or magnesium to potassium, to correspond advantageously to those of water in the natural habitat of the aquatic organisms.

It is understood that sodium chloride may be used as a substitute for sodium sulphate.

Brackish water or salt water according to the invention is sulphate-free or has at least a low sulphate content, depending on the salt composition used to produce it.

Conveniently, the salt composition contains potassium chloride (KCl), preferably less than 5 mol % in relation to the total amount of substance in the salt composition, in particular between 0.5 mol % and 4.0 mol %, particularly preferably between 1.5 mol % and 2.25 mol %.

In one embodiment of the invention, the salt composition contains calcium chloride (CaCl₂)), preferably less than 5 mol % in relation to the total amount of substance in the salt composition, in particular between 0.5 mol % and 4 mol %, particularly preferably between 1.50 mol % and 2.25 mol %. Calcium and chloride ions are essential for the growth of aquatic organisms. Calcium chloride is particularly soluble in water, so that a rearing tank can be used for farming more quickly than if another calcium source is used. Downtimes are reduced and an increase in productivity is possible.

The inventor has recognized that for a sulphate-free salt composition or a salt composition that has a low sulphate content, a sulphate salt can be replaced by a chloride salt, wherein ion ratios required for farming aquatic organisms in a farming installation operated with saltwater or brackish water according to the invention, for example an ion ratio of magnesium ions to calcium ions or magnesium ions to potassium ions, advantageously correspond to or are at least very similar to those of water of the natural habitat of the aquatic organisms.

In a further embodiment of the invention, the salt composition contains sodium carbonate (Na₂CO₃), preferably up to 0.5 mol % in relation to the total amount of the substance in the salt composition, in particular between 0.01 mol % and 0.15 mol %, particularly preferably 0.065 mol %. Sodium carbonate has a significantly higher solubility in water than sodium bicarbonate, which is known from the prior art as a carbonate supplier for the production of salt or brackish water for farming installations. Due to the higher solubility, the farming installation is available more quickly for the further farming of aquatic organisms after a change of the saltwater or brackish water with which the farming installation is operated. Downtimes are reduced.

Conveniently, the salt composition contains sodium bicarbonate (NaHCO₃), preferably up to 0.5 mol % in relation to the total amount of substance in the salt composition, in particular up to 0.35 mol %, especially preferably between 0.20 mol % and 0.31 mol %. Sodium bicarbonate is also referred to as sodium hydrogen carbonate.

Although sodium bicarbonate is less soluble in water than sodium carbonate, it is much easier to store. While sodium carbonate is highly hygroscopic and must either be stored in an airtight container or in a dry atmosphere, sodium bicarbonate can be stored in air-permeable bags without significantly changing its properties. This is advantageous for long transportation routes to a farming installation or for long storage times in the farming installation; on-time delivery is not necessary.

It is conceivable that sodium bicarbonate is used to produce a salt composition which requires a particularly precise adjustment of a pH value of the saltwater or brackish water produced therefrom, with which a farming installation according to the invention is operated.

A salt composition that has a low sulphate content contains, for example, up to 5 mol % sulphate (SO₄²⁻). A suitable sulphate is, for example, a sulphate selected from the group consisting of sodium sulphate, magnesium sulphate, potassium sulphate and calcium sulphate, preferably selected from the group consisting of sodium sulphate and magnesium sulphate. In one embodiment, a salt composition that has a low sulphate content contains up to 5 mol % sodium sulphate (Na₂SO₄), in a further embodiment, a salt composition that has a low sulphate content contains up to 5 mol % magnesium sulphate (MgSO₄), in each case in relation to the total amount of substance in the salt composition.

The inventor has recognized that in a salt composition that has a low sulphate content, sodium sulphate can be replaced by magnesium sulphate without any negative influence on the growth of aquatic organisms. Due to the fact that sodium sulphate is more expensive than magnesium sulphate, a particularly cost-effective salt composition is advantageously created. A farming installation according to the invention is particularly economical to operate.

With a salt composition that has a low sulphate content, a magnesium sulphate content of 4.28 mol % in relation to the total amount of substance in the salt composition has proven to be advantageous. This gives optimum harvesting results, i.e. rapid growth with a low loss rate due to aquatic organisms dying before harvesting begins.

In one embodiment of the invention, a sulphate-free salt composition contains between 7.5 mol % and 12 mol % magnesium chloride (MgCl₂) in relation to the total amount of substance in the salt composition, preferably between 9.0 and 10.0 mol %. This proportion has been found to be particularly advantageous for achieving the optimum ion ratio of magnesium to calcium and magnesium to potassium in the brackish water or salt water of the farming installation for the metabolism of aquatic organisms. These ion ratios are very relevant to the optimal growth of aquatic organisms. Advantageously, a particularly efficient farming installation is created.

In a further embodiment of the invention, a salt composition that has a low sulphate content contains between 4.0 mol % and 7.0 mol % magnesium chloride (MgCl₂) in relation to the total amount of substance in the salt composition, preferably between 5.0 and 6.0 mol %. This proportion has been found to be particularly advantageous in order to achieve the optimum cation ratio of magnesium to calcium and magnesium to potassium in the brackish water or saltwater of the farming installation for the metabolism of aquatic organisms.

In one embodiment of the invention, the salt composition is magnesium sulphate-free or has a low magnesium sulphate content. Advantageously, a salt composition is created which, compared to that for the production of artificial salt water, has no sulphate at all, or only a small proportion which is achieved by adding magnesium sulphate. Such a salt composition according to the invention is synthetic and cannot be produced by drying seawater.

Conveniently, a salt composition that has a low sulphate content or a sulphate-free salt composition according to the invention for the production of brackish water or saltwater for an installation for farming aquatic organisms, in particular for farming fish or crustaceans, contains between 70 mol % and 99.9 mol % sodium chloride (NaCl) and between 0.1 mol % and 30 mol % magnesium chloride (MgCl₂), in each case in relation to the total amount of substance in the salt composition.

It goes without saying that the mol % of the salts contained in the salt composition refer to their mol % before the production of brackish water or salt water. The skilled person is aware that the mol % may change during the production of the brackish water or salt water.

The salinity of brackish water or saltwater according to the invention, which is producible or which is produced with a salt composition according to the invention, is between 0.10% and 5.0%, preferably between 2.5% and 3.5%. A salinity of 2.5% to 3.5% is particularly suitable for farming marine animals.

When specifying a salinity, the percentages refer to the mass proportion of salt in the water. For example, a salinity of 1.0% means that 10 g of salt is added to 1 kg of water to produce saltwater.

Brackish water has a salinity of between 0.1% and 1.0%, while saltwater has a salinity of more than 1.0%. Seawater may have a salinity of 3.0% to 3.5%.

In a method according to the invention for producing brackish water or salt water for an installation for farming aquatic organisms with a salinity required for farming, a salt composition is added to fresh water, in particular into tap water, groundwater or surface water, for example from lakes. Its ion content is negligible compared to the ion content that the brackish or salt water according to the invention should have.

An aquatic organism according to the invention, which has been bred in a farming installation according to the invention, differs from aquatic organisms known from prior art in that it can be determined from the kidney activity of the aquatic organisms whether the aquatic organisms were bred in sulphate-free or low-sulphate saltwater or brackish water. Sulphate detectable in aquatic organisms is formed, for example, by metabolizing food containing amino acids or by ingestion from the saltwater or brackish water in which the aquatic organisms are farmed. For example, the inventor was able to demonstrate that aquatic organisms whose natural habitat is saltwater and which were bred in a farming installation operated with low-sulphate or sulphate-free salt water in accordance with the invention exhibited lower kidney activity than comparable aquatic organisms bred in their natural habitat.

In the case of dead aquatic organisms according to the invention, it can be determined by examining the kidneys whether they were reared in low-sulphate or sulphate-free salt or brackish water.

It is understood that low-sulphate and sulphate-free water is such saltwater or brackish water with which the farming installation is operated and which has been produced with a low-sulphate or sulphate-free salt composition.

A salt composition known from the prior art for the production of artificial seawater for operating an aquaculture installation has the substance amount fraction shown in Table 1 below in relation to the total amount of substance in the salt composition:

TABLE 1
Salt composition known from prior art
for producing artificial saltwater

| Chemical compound | Amount of substance (mol %) |
|---|---|
| Sodium chloride | 88.06 |
| Magnesium chloride | 1.50 |
| Magnesium sulphate | 7.00 |
| Calcium chloride | 1.63 |
| Potassium chloride | 1.52 |
| Sodium bicarbonate | 0.25 |
| Sodium carbonate | 0.04 |

Brackish water or salt water from a farming installation produced with this composition (7 mol % magnesium sulphate) has a high risk of harvest loss-up to 2%-due to the formation of hydrogen sulphide in the sediment area.

The invention is explained in more detail below using examples of embodiments.

### EXAMPLE 1

A salt composition that has a low sulphate content according to the invention has a composition according to Table 2.1 below:

TABLE 2.1
Salt composition with a low sulphate
content according to the invention

| Chemical compound | Amount of substance (mol %) |
|---|---|
| Sodium chloride | 86.09 |
| Magnesium chloride | 5.51 |
| Magnesium sulphate | 4.28 |
| Calcium chloride | 1.90 |
| Potassium chloride | 1.87 |
| Sodium bicarbonate | 0.30 |
| Sodium carbonate | 0.06 |

Saltwater with a salinity of 3.0%, which is prepared with a salt composition according to Table 2.1, has an ion concentration according to Table 2.2 below:

TABLE 2.2
Saltwater that has a low sulphate content with
a salinity of 3.0% according to the invention

| | Concentration | Amount of substance |
|---|---|---|
| Ion | (mol/l) | (mol %) |
| Sodium (Na)⁺ | 0.41 | 42.83 |
| Chloride (Cl)⁻ | 0.47 | 48.17 |
| Magnesium (Mg)²⁺ | 0.05 | 4.84 |
| Sulphate (SO)₄²⁻ | 0.02 | 2.12 |
| Calcium (Ca)²⁺ | 0.01 | 0.94 |
| Potassium (K)⁺ | 0.01 | 0.92 |
| Bicarbonate (HCO)³⁻ | 0.0014 | 0.15 |
| Carbonate (CO)₃²⁻ | 0.00025 | 0.03 |

### EXAMPLE 2

A sulphate-free salt composition according to the invention has a composition according to Table 3.1 below:

TABLE 3.1
Sulphate-free salt composition according to the invention

| Chemical compound | Amount of substance (mol %) |
|---|---|
| Sodium chloride | 86.46 |
| Magnesium chloride | 9.52 |
| Magnesium sulphate | 0.0 |
| Calcium chloride | 1.85 |
| Potassium chloride | 1.82 |
| Sodium bicarbonate | 0.29 |
| Sodium carbonate | 0.06 |

Since a certain amount of magnesium is required for farming aquatic organisms, omission of magnesium sulphate is compensated for by an increase in the amount of magnesium chloride, i.e. magnesium sulphate is replaced by magnesium chloride.

The composition according to example 2 enables the production of brackish water or saltwater for a farming installation whose aquatic organisms have a growth curve like those farmed in brackish water or saltwater, which is producible by a composition according to example 1, and in which almost no harvest loss-less than 0.5%-occurs due to hydrogen sulphide released from the so-called sediment.

Salt water with a salinity of 3.0%, which is prepared with a salt composition according to Table 3.1, has an ion concentration according to Table 3.2 below:

TABLE 3.2
Sulphate-free salt water with a salinity
of 3.0% according to the invention

| | Concentration | Amount of substance |
|---|---|---|
| Ion | (mol/l) | (mol %) |
| Sodium (Na)⁺ | 0.43 | 43.01 |
| Chloride (Cl)⁻ | 0.51 | 50.29 |
| Magnesium (Mg)²⁺ | 0.05 | 4.72 |
| Sulphate (SO)₄²⁻ | 0 | 0 |
| Calcium (Ca)²⁺ | 0.01 | 0.92 |
| Potassium (K)⁺ | 0.01 | 0.91 |
| Bicarbonate (HCO)³⁻ | 0.00136 | 0.13 |
| Carbonate (CO)₃²⁻ | 0.00024 | 0.02 |

### EXAMPLE 3

Another sulphate-free salt composition according to the invention has a composition according to Table 4.1 below:

TABLE 4.1
sulphate-free salt composition according to
the invention without sodium bicarbonate

| Chemical compound | Amount of substance (mol %) |
|---|---|
| Sodium chloride | 86.51 |
| Magnesium chloride | 9.53 |
| Magnesium sulphate | 0.00 |
| Calcium chloride | 1.86 |
| Potassium chloride | 1.84 |
| Sodium bicarbonate | 0.00 |
| Sodium carbonate | 0.26 |

The composition according to example 3 makes it possible to produce brackish water or saltwater for a farming installation, the aquatic organisms of which have a growth curve like those which are bred in brackish or salt water which can be produced by a composition according to example 1 or 2, and in which almost no harvest loss-less than 0.5%-occurs due to hydrogen sulphide released from the so-called sediment.

The composition according to example 3 has the advantage that the high solubility of sodium carbonate and omission of sodium bicarbonate made it possible to reduce the downtime of the farming installation by several hours during a water change.

Saltwater with a salinity of 3.0%, which is prepared with a salt composition according to Table 4.1, has an ion concentration according to Table 4.2 below:

TABLE 4.2
Sulphate-free and bicarbonate-free salt water with
a salinity of 3.0% according to the invention

| | Concentration | Amount of substance |
|---|---|---|
| Ion | (mol/l) | (mol %) |
| Sodium (Na)⁺ | 0.44 | 43.06 |
| Chloride (Cl)⁻ | 0.51 | 50.26 |
| Magnesium (Mg)²⁺ | 0.05 | 4.72 |
| Sulphate (SO)₄²⁻ | 0.00 | 0.00 |
| Calcium (Ca)²⁺ | 0.01 | 0.92 |
| Potassium (K)⁺ | 0.01 | 0.91 |
| Bicarbonate (HCO)³⁻ | 0.00 | 0.00 |
| Carbonate (CO)₃²⁻ | 0.00132 | 0.13 |

It is understood that the invention is not limited to these examples. In particular, it is conceivable that brackish water or salt water according to the invention has a salinity other than that explained, for example 0.75% or 3.5%.

It is also conceivable that a sulphate salt other than magnesium sulphate could be used to produce low-sulphate saltwater or brackish water, for example sodium or potassium sulphate.

1. Installation for farming aquatic organisms, in particular fish or crustaceans, which has a rearing tank containing saltwater or brackish water, wherein the saltwater or brackish water is producible or is produced using a salt composition that contains between 70 mol % and 99.9 mol % sodium chloride (NaCl) and between 0.1 mol % and 30 mol % magnesium chloride (MgCl₂), in each case in relation to the total amount of substance in the salt composition, characterized in that the salt composition is sulphate-free or has at least a low sulphate content.

2. A farming installation according to claim 1, characterized in that the salt composition contains potassium chloride (KCl), preferably less than 5 mol % in relation to the total amount of substance in the salt composition, in particular between 0.5 mol % and 4.0 mol %, particularly preferably between 1.5 mol % and 2.25 mol %.

3. A farming installation according to claim 1, characterized in that the salt composition contains calcium chloride (CaCl₂)), preferably less than 5 mol % in relation to the total amount of substance in the salt composition, in particular between 0.5 mol % and 4 mol %, particularly preferably between 0.50 mol % and 2.25 mol %.

4. A farming installation according to claim 1, characterized in that that the salt composition contains sodium carbonate (Na₂CO₃), preferably up to 0.5 mol-% in relation to the total amount of substance in the salt composition, in particular between 0.01 mol-% and 0.15 mol-%, particularly preferably 0.065 mol-%.

5. A The farming installation according to claim 1, characterized in that the salt composition contains sodium bicarbonate (NaHCO₃), preferably up to 0.5 mol % in relation to the total amount of substance in the salt composition, in particular up to 0.35 mol %, particularly preferably between 0.20 mol % and 0.31 mol %.

6. A farming installation according to claim 1, characterized in that a salt composition that has a low sulphate content contains magnesium sulphate (MgSO₄), preferably less than 5.0 mol % in relation to the total amount of substance in the salt composition, particularly preferably between 4.15 mol % and 4.35 mol %.

7. A farming installation according to claim 1, characterized in that a sulphate-free salt composition contains between 7.5 mol % and 12 mol % magnesium chloride (MgCl₂) in relation to the total amount of substance in the salt composition, preferably between 9.0 and 10.0 mol %.

8. A farming installation according to claim 1, characterized in that a salt composition that has a low sulphate content contains between 4.0 mol % and 7.0 mol % magnesium chloride (MgCl₂) in relation to the total amount of substance in the salt composition, preferably between 5.0 and 6.0 mol %.

9. Salt composition for producing brackish water or saltwater for an installation for farming aquatic organisms, in particular for farming fish or crustaceans, which contains between 70 mol % and 99.9 mol % sodium chloride (NaCl) and between 0.1 mol % and 30 mol % magnesium chloride (MgCl₂), in each case in relation to the total amount of substance in the salt composition, characterized in that the salt composition is sulphate-free or has at least a low sulphate content.

10. Brackish water or saltwater for an installation for farming aquatic organisms, in particular fish or crustaceans, which is producible or is produced by a salt composition according to claim 9.

11. Brackish water or saltwater according to claim 10 characterized in that the salinity of the brackish water or saltwater is between 0.10% and 5%, preferably between 2.5% and 3.5%

12. Method for producing brackish water or saltwater for an installation for farming aquatic organisms according to claim 1, characterized in that a salt composition according to claim 9 is added to fresh water, in particular tap water, groundwater or surface water, wherein a salinity of between 1.0% and 5.0% is set.

13. Aquatic organism, in particular fish or crustacean, which is bred or has been bred in an installation for farming aquatic organisms according to claim 1, which has brackish water or saltwater with a salinity between 0.1% and 5.0%, which brackish water or saltwater is producible or is produced with a salt composition according to claim 9.

14. A salt composition according to claim 9 for operating an installation for farming aquatic organisms.

15. The method for producing brackish water or saltwater according to claim 10 for operating an installation for farming aquatic organisms.
